(19) United States
(12) Patent Application Publication
(10) Pub. No.: US 2006/0181508 A1
(43) Pub. Date: Aug. 17, 2006

(54) Operation input device and electronic appliances using the same

(75) Inventors: Takeshi Arihara, Kyoto-shi (JP); Kazuaki Miyoshi, Ritto-shi (JP)

Correspondence Address: OSHA LIANG L.L.P., 1221 MCKINNEY STREET, SUITE 2800, HOUSTON, TX, 77010, US

(73) Assignee: OMRON Corporation, Kyoto (JP)

(21) Appl. No.: 11/355,707

(22) Filed: Feb. 16, 2006

(30) Foreign Application Priority Data
Feb. 17, 2005 (JP) 2005-040952

(51) Int. Cl. G09G 5/00

(52) U.S. Cl. 345/156

(57) ABSTRACT

An operation input device excellent in an operation feeling, capable of smooth rotation and having less occurrence of dust includes a base 10; a support shaft 30 elastically implanted to and supported by the base 10 in such a manner as to be capable of tilting; a printed substrate 20 equipped on an upper surface thereof with a plurality of bush button switches 34a to 34d and Hall IC 24a and 24b mounted thereto, and put on and integrated with the base 10; an operation plate 40 arranged on the printed substrate 20; and an operation dial 50 having a ring-like magnet 55 having N poles and S poles alternately arranged on a lower surface thereof and supported to an upper end portion of the support shaft 30 in such a manner as to be capable of rotation. The Hall IC 24a and 24b detect the change of a magnetic flux of the ring-like magnet 55 and a rotating direction when the operation dial 50 is rotated, and the push button switches 34a to 34d are driven through the operation plate 40 when an outer peripheral edge portion of the operation dial 50 is pushed down.

### BACKGROUND OF THE INVENTION

1. Field of the Invention

This invention relates to an operation input device that can be applied to various electronic appliances such as mobile telephones, mobile music players, television receives, video recorders, and so forth.

2. Description of the Prior Art

A heretofore known operation input device used for mobile telephones, etc, has a construction in which push button switches arranged on an upper surface of a base are driven through an operation shaft implanted to the base, for example.

In other words, an operation knob 16 fitted to an upper end portion of the operation shaft 21 is rotated to the right and left to rotate a rotary member 22 and is then pushed to move down the operation shaft 21 to operate a switch portion (refer to Patent Document 1).

[Patent Document 1] JP-A-2002-25395

### SUMMARY OF THE INVENTION

According to the input device described above, however, the operation shaft 21 is fitted to and supported by a bearing 2 in such a manner as to be capable of rotation and vertical movement when the operation knob 6 is rotated and is prevented from falling off by a washer 4. Therefore, it is not easy to smoothly rotate the operation shaft 21. In addition, operation feeling is not good, a smooth rotation operation cannot be obtained easily and dust is likely to occur.

In view of the problems described above, the invention aims at providing an operation input device that is excellent in operation feeling, can make a smooth rotation operation and is less of the occurrence of dust.

To solve the problems described above, the operation input device according to the invention includes a base; a support shaft elastically implanted to and supported by the base in such a manner as to be capable of tilting; a printed substrate equipped on an upper surface thereof with a plurality of push button switches and magnetic field detection elements mounted thereto, and put on and integrated with the base; an operation plate arranged on the printed substrate; and an operation dial having a ring-like magnet having N poles and S poles alternately arranged on a lower surface thereof and supported by an upper end portion of the support shaft in such a manner as to be capable of rotation; wherein the magnetic field detection elements detect the change of a magnetic flux of the ring-like magnet and a rotating direction when the operation dial is rotated, and the push button switches are driven through the operation plate when an outer peripheral edge portion of the operation dial is pushed down.

According to the invention when the outer peripheral edge portion of the operation dial is pushed down, the support shaft tilts and drives the push button switches through the operation plate. Therefore, the operation dial is free from catch that has been observed in the prior art example, but can acquire a high operation feeling. The operation dial is supported by the upper end portion of the support shaft and does not touch other components. Therefore, the smooth rotation operation can be acquired and the occurrence of dust can be prevented.

In an embodiment of the invention, the support shaft may be inserted into a shaft hole of the base and a lower surface edge portion of the shaft hole of the base and a lower end flange portion of the support shaft may clamp the ring-like elastic body so that the support shaft can be elastically supported by and implanted to the base and can tilt. The support shaft may be inserted into a shaft hole of the base and the ring-like elastic body is arranged between an inner peripheral surface of the shaft hole of the base and an outer peripheral surface of the support shaft so that the support shaft can be elastically supported by and implanted to the base and can tilt.

According to this embodiment, the same effect as described above. In addition, the selection rang of design can be enlarged and design freedom can be improved.

According to another embodiment, the support shaft may include a lower shaft portion and an upper shaft portion that are separably integrated with each other by meshing. Because the support shaft can be divided into two parts in this embodiment, the production of the support shaft becomes easy as a whole even when the outer peripheral shape of the support shaft becomes complicated.

According to still another embodiment, a slide ring having a small coefficient of friction may be arranged between the operation dial and the operation plate.

According to this embodiment, it is possible to acquire an operation input device capable of a smoother rotation operation.

The invention has the effect of acquiring an electronic appliance excellent in operation feeling, capable of a smooth rotation operation and having less occurrence of dust by using the operation input device for various electronic appliances such as mobile telephones, mobile music players, and so forth.

### BRIEF DESCRIPTION OF THE DRAWINGS

FIG. 1 is a perspective view of a mobile telephone to which an operation input device according to the invention is applied;

FIGS. 2A and 2B are upper and lower perspective views of the operation input device shown in FIG. 1, respectively;

FIGS. 3A, 3B and 3C are a plan view, a sectional view taken along a line B-B and a sectional view taken along a line C-C of the operation input device shown in FIG. 1, respectively;

FIG. 4 is an upper exploded perspective view useful for explaining an assembly process of the operation input device shown in FIG. 2;

FIG. 5 is an upper exploded perspective view of the operation input device shown in FIG. 2;

FIG. 6 is a lower exploded perspective view useful for explaining an assembly process of the operation input device shown in FIG. 2;

FIG. 7 is a lower exploded perspective view of the operation input device shown in FIG. 2;

FIGS. 8A, 8B and 8C are a plan view, a sectional view taken along a line B-B and a sectional view taken along a line C-C of an operation input device according to the second embodiment of the invention;

FIGS. 9A and 9B are an upper exploded perspective view and a partial perspective view for explaining an assembly process of the operation input device shown in FIGS. 8A to 8C;

FIG. 10 is an upper exploded perspective view of the operation input device shown in FIGS. 8A to 8C;

FIG. 11 is a lower exploded perspective view for explaining the assembly process of the operation input device shown in FIGS. 8A to 8C; and

FIG. 12 is a lower exploded perspective view of the operation input device shown in FIGS. 8A to 8C.

### DESCRIPTION OF THE PREFERRED EMBODIMENTS

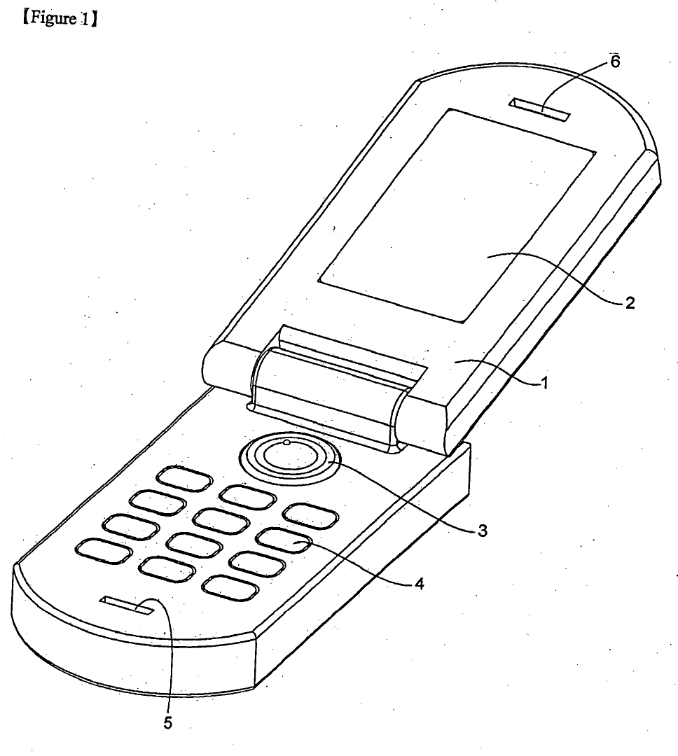

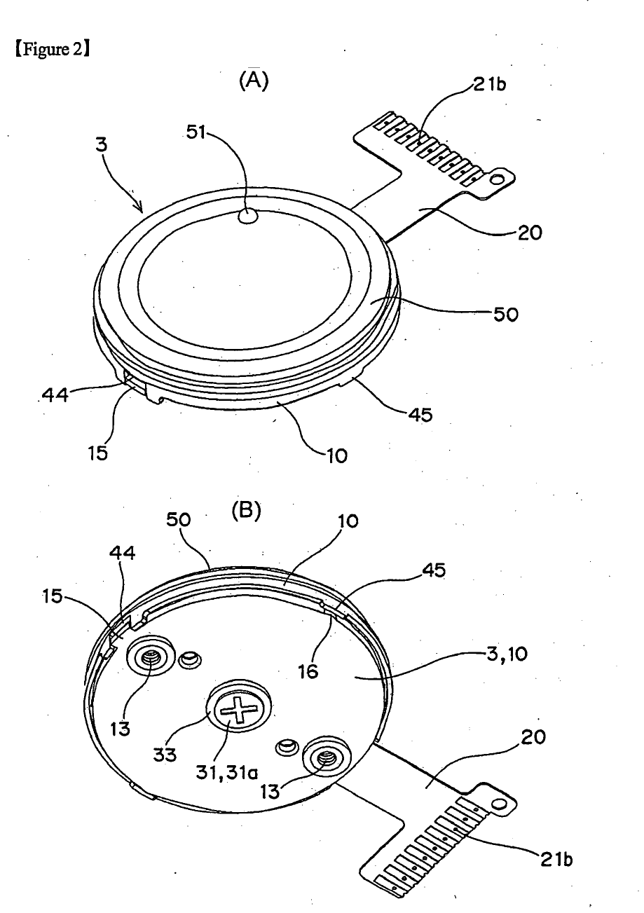

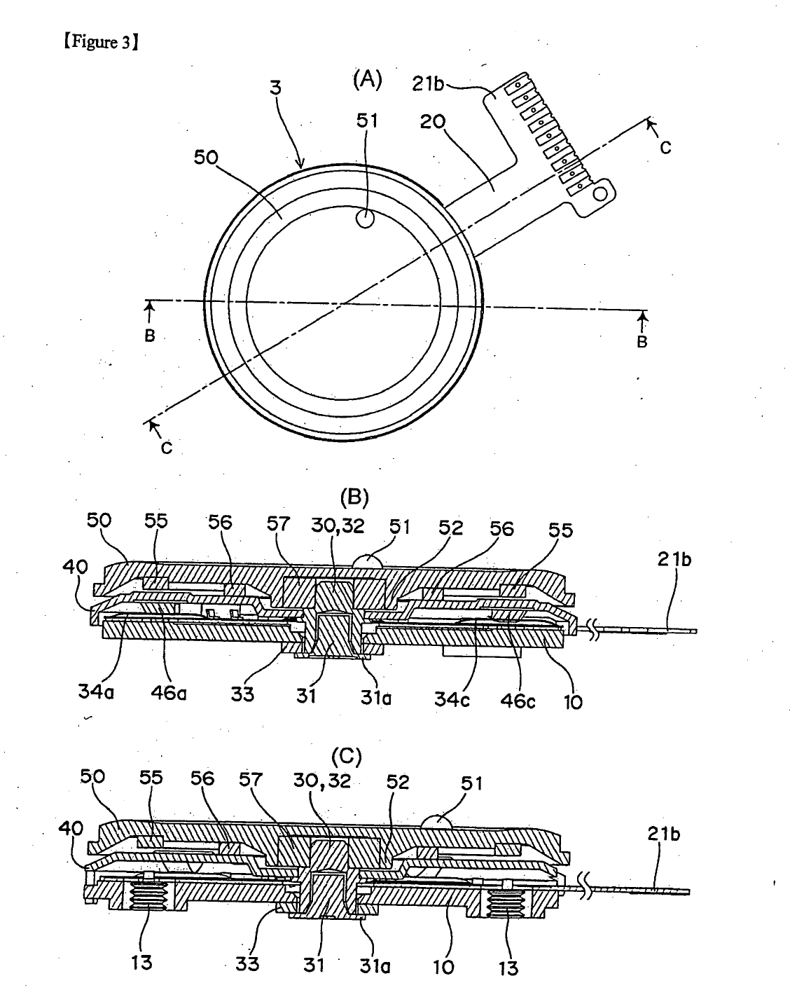

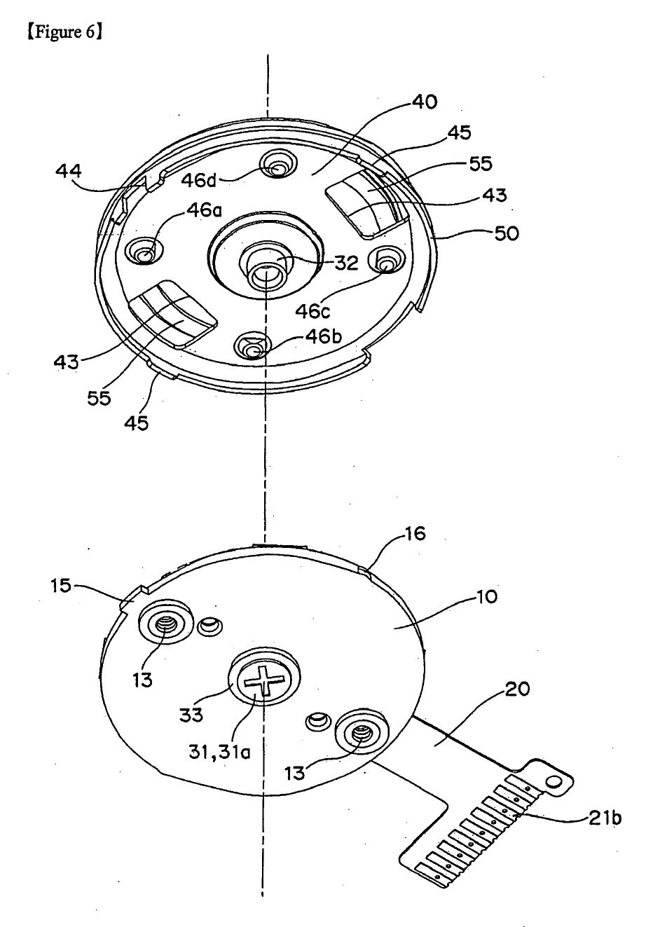

Operation input devices according to preferred embodiments of the invention will be explained with reference to FIGS. 1 to 12 of the accompanying drawings.

The operation input device according to the first embodiment represents the case where it is applied to a mobile telephone 1 as shown in FIGS. 1 to 7. As shown in FIG. 1, in particular, the mobile telephone 1 of the first embodiment scrolls a scroll bar (not shown in the drawings) inside a monitor 2 by the operation input device 3 and can select and output instruction through push button switches 34a to 34d that will be later described. Incidentally, reference numeral 4 denotes a ten-key, reference numeral 5 denotes a microphone and reference numeral 6 denotes a speaker.

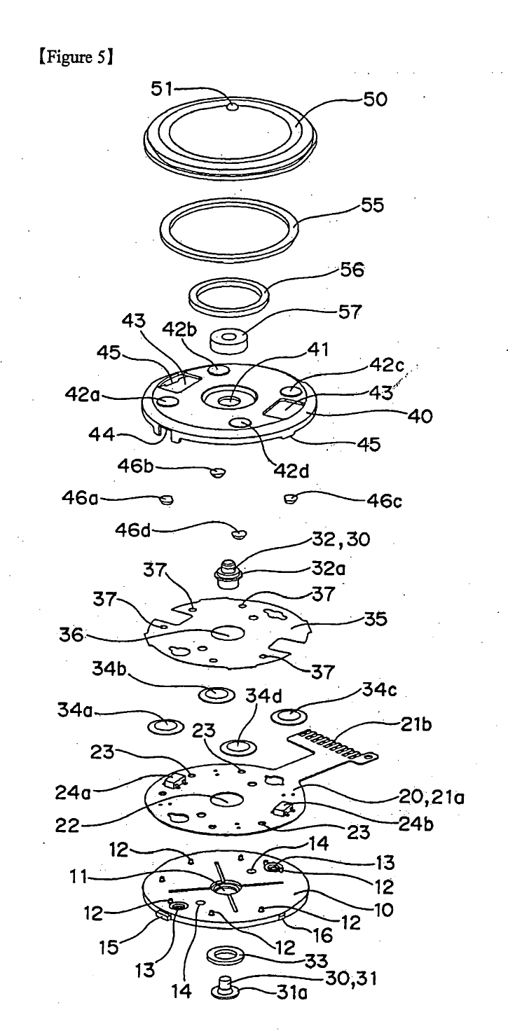

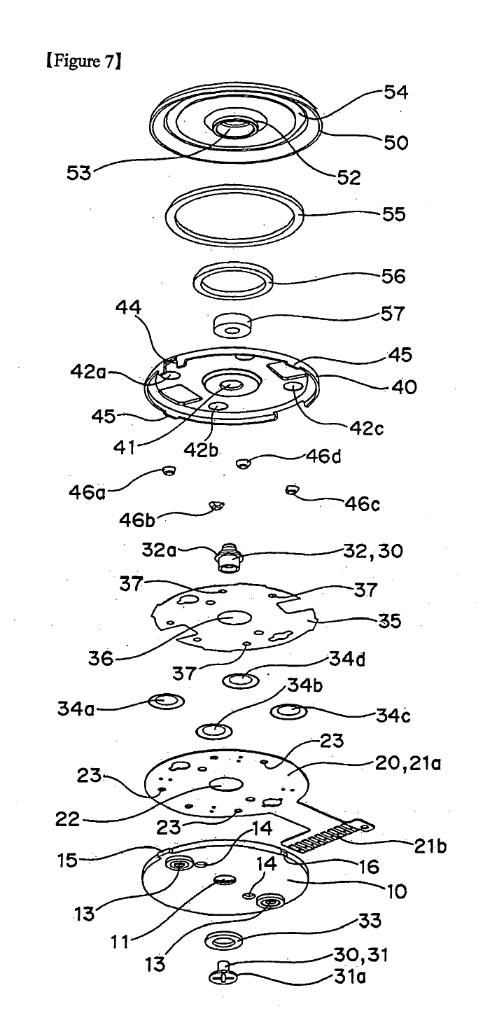

As shown in FIGS. 5 and 7, the operation input device 3 includes a base 10 to which a printed substrate 20 formed of a flexible resin film is bonded and integrated, a support shaft 30 having a lower shaft portion 31 and an upper shaft portion 32 and implanted and supported flexibly at a center of the base 10 in such a fashion as to be capable of inclination, an operation plate 40 inserted though and fixed to the support shaft 30 and an operation dial 50 assembled to the upper end of the support shaft 30 in such a manner as to be capable of rotating through a bearing 57.

The base 10 has a substantially round flat surface and a plurality of positioning protuberances 12 are formed on the same circumference with a shaft 11 formed at the center as their center in such a manner as to protrude upward. A pair of fixing screw holes 13 and 13 and a pair of positioning holes 14 and 14 for assembly are arranged on the base 10 in such a manner as to interpose the shaft hole 11 between them. The base 10 has further a rotation stop protuberance 15 and a pair of pressure contact protuberances 16 and 16 around the outer peripheral end face.

The printed substrate 20 includes a substantially round substrate main body 21a covered with peel paper (not shown in the drawings) to the back of which adhesive is applied, and a lead portion 21b. The substrate main body 21a has a plurality of positioning holes 23 on the same circumference with a center hole 22 at the center as the center and a pair of Hall IC 24a and 24b so mounted as to interpose the center hole 22 between them. The substrate main body 21a has four conductor portions (not shown in the drawings) that are arranged in an equal pitch on the same circumference with the center hole 22 as the center. Flat dome-like push button switches 34a to 34d bonded to the back surface of a later-appearing sheet-like insulating cover 35 are mounted to the conductor portions, respectively.

The support shaft 30 has the lower shaft portion 31 and the upper shaft portion 32 that are separably integrated with each other by screw meshing on the same axis. The lower shaft portion 31, in particular, clamps a ring-like elastic body 33 with its flange portion 31a and the base 10 described above. On the other hand, the upper shaft portion 32 is integrated by welding at its flange portion 32a with a later-appearing operation plate 40.

The sheet-like insulating cover 35 mounts the flat dome-like button switches 34a to 34d bonded in advance to its back surface to the conductor portions of the substrate main body 21a and covers them, respectively. The sheet-like insulating cover 35 has a plurality of positioning holes 37 for assembly with a center hole 36 formed at its center as their center.

The operation plate 40 has four protuberances 42a to 42d that are arranged on the same circumference with a shaft hole 41 formed at its center as their center in such a manner as to protrude and a pair of windows 43 and 43 that interpose the shaft hole 41 between them. The operation plate 40 has a rotation stop slot 44 formed at an outer peripheral edge, and a pair of pressure contact tongues 45 are cut out from the outer peripheral edge. Operation elastic bodies 46a to 46d are bonded to the back surface of the protuberances 42a to 42d described above, respectively, and the push button switches 34ao 34d can be pushed down. After the upper end of the upper shaft portion 32 is inserted into the shaft hole 41, the operation plat 40 is integrated by welding with the flange portion 32a.

The operation dial 50 has on its upper surface an operation protuberance 51 as shown in FIG. 5. The operation dial 50 further has a recess 53 for fixing a later-appearing bearing 57 at the center of the lower end surface of the protuberance 52 that is so formed at the center of the lower surface as to protrude upward as shown in FIG. 7. A ring-like groove 54 for fitting and fixing a ring-like magnet 55 is concentrically arranged with the recess 53 as the center.

The ring-like magnet 55 has N poles and S poles that is alternately arranged, and is fitted and fixed to the ring-like groove 54 of the operation dial 50. To secure smoother rotation in this embodiment, a slide ring 56 having a small coefficient of friction is fitted to a peripheral base portion of the protuberance 52. Therefore, when the slide ring 56 fitted to the operation dial 50 keeps contact with the upper surface of the operation plate 40, the ring-like magnet 55 somewhat floats up from the upper surface of the protuberances 42a to 42d.

To secure the smooth rotation of the operation dial 50, the bearing 57 is fitted and fixed to the recess 53 of the operation dial 50. Therefore, the operation dial 50 rotates through the slide ring 56 and the bearing 57 and the smooth rotation becomes possible.

Next, the assembly procedure of the operation input device 3 having the constituent components described above will be explained.

First, after the ring-like elastic body 33 is bonded to the edge portion of the back surface of the shaft hole 11 of the base 10, a positioning pin of a jig, not shown, is inserted into the assembly positioning hole 14 of the base 10 to execute positioning. The positioning protuberances 12 of the base 10 are fitted into the positioning holes 23 of the printed substrate 20 having the pair of Hall IC 24a and 24b mounted thereto to execute positioning and bonding is made. Next, the positioning holes 37 of the sheet-like insulating cover 35 having the push button switches 34a to 34d bonded to the back surface thereof are fitted to the positioning protuberances 12 of the base 10. The insulating cover 35 is then bonded to the upper surface of the printed substrate 20 to establish electric connection and is integrated.

On the other hand, the upper end of the upper shaft portion 32 is fitted into the shaft hole 41 of the operation plate 40 and is integrated with the flange portion 32a by welding. The operation elastic bodies 46a to 46d are bonded to the back surface of the protuberances 42a to 42d, respectively. The lower shaft portion 31 is fitted into the shaft hole 11 of the base 10 and is meshed with the upper surface portion 32 in such a manner as to support the operation plate 40 on the base 10 through the support shaft 30 and to clamp the ring-like elastic body 33 by the flange portion 31a of the lower shaft portion 31 and the base 10.

Next, the ring-like magnet 55 is fitted and bonded to the ring-like groove 54 of the operation dial 50 and the slide ring 56 is bonded to the peripheral base portion of the protuberance 52. The bearing 57 is fitted to the recess 53 disposed in the protuberance 52 and is fixed by the adhesive.

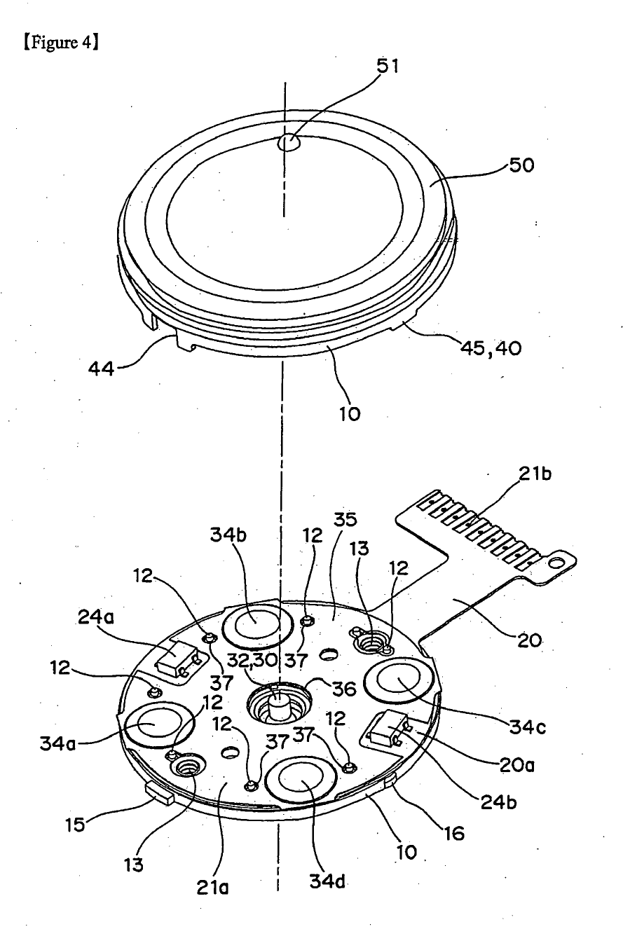

Next, as shown in FIG. 4, the bearing 57 fixed to the operation dial 50 is pushed into the upper end of the upper shaft portion 32 exposed from the center hole 36 of the sheet-like insulating cover 35 and is integrated with the upper shaft portion 32. In consequence, the operation dial 50 is supported by the support shaft 30 through the bearing 57 in such a manner as to be capable of rotation. Though the support shaft 30 is fixed to the base 10 through the ring-like elastic body 33, a small clearance exists between the support shaft 30 and the shaft hole 11 of the base 10. Therefore, when the outer peripheral edge portion of the operation dial 50 is pushed, the support shaft 30 somewhat inclines and can drive the push button switches 34a to 34d. Furthermore, rotation stop notch 44 of the operation plate 40 meshes with the rotation stop protuberance 15 of the base 10 and stops rotation of the operation plate 40. Particularly because the pressure contact tongues 45 of the operation plate 40 come into pressure contact with the pressure contact protuberances 16 of the base 10, shake does not occur in the operation plate 40.

Next, the operation method of the operation input device 3 having the construction described above will be explained.

When the operation dial 50 is rotated, the ring-like magnet 55 integral with the operation dial 50 rotates and the pair of Hall IC 24a and 24b detect the change of the magnetic field, respectively, and also detect the rotating direction and the rotating distance on the basis of the detection result. The detection result is reflected on the movement of the scroll bar on the screen display of the monitor 2 through a control circuit not shown in the drawings. Incidentally, though the support shaft 30 is supported by the base 10 through the ring-like elastic body 33, unnecessary shake does not occur in the support shaft 30 during the rotation of the operation dial 50 and the desired operation feeling can be secured because the ring-like elastic body 33 has predetermined hardness.

Next, when the scroll bar reaches the desired position, the selection instruction is outputted by pushing the peripheral edge portion of the operation dial 50. In other words, when the outer peripheral edge portion of the operation dial 50 is pushed down, the ring-like elastic body 33 supporting the support shaft 30 undergoes elastic deformation and the support shaft 30 inclines a little. Therefore, the slide ring 56 pushes the operation plate 40, for example, and the ring-like magnet 55 pushes down the protuberance 42a of the operation plate 40, so that the operation elastic body 46a bonded to the back surface of the protuberance 42a drives the push button switch 34a through the sheet-like insulating cover 35.

The ring-like elastic body 33 returns to its original shape and the support shaft 30 returns to its original position when the operator detaches the finger from the operation dial 50. Consequently, the slide ring 56 fitted to the operation dial 50 merely comes into sliding contact with the upper surface of the operation plate 40 and the smooth rotation operation is not lost.

According to this embodiment, the protuberances 42a to 42d are provided to the operation plate 40 and the operation elastic bodies 46a to 46d are bonded. Therefore, even when the push-down position of the operator is not correct, the corresponding one of the push button switches 34a to 34d can be correctly pushed down through the protuberances 42a to 42d and the operation elastic bodies 46a to 46d, and the operation mistake can be prevented.

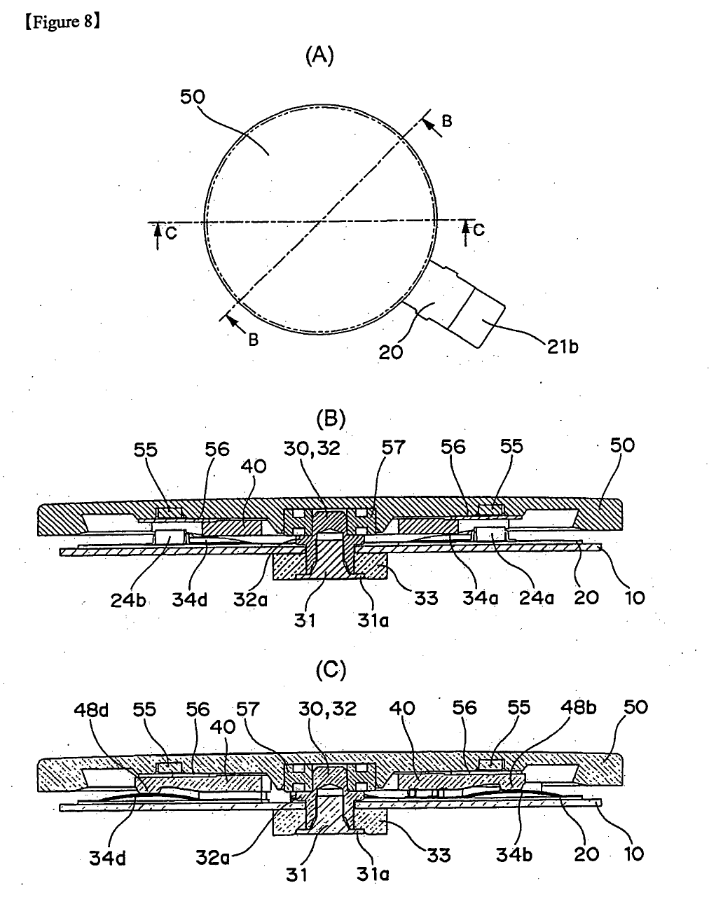

The second embodiment of the invention has substantially the same basic construction as that of the first embodiment as shown in FIGS. 8 to 12. Therefore, the same reference numeral will be used to identify the same member for explanation.

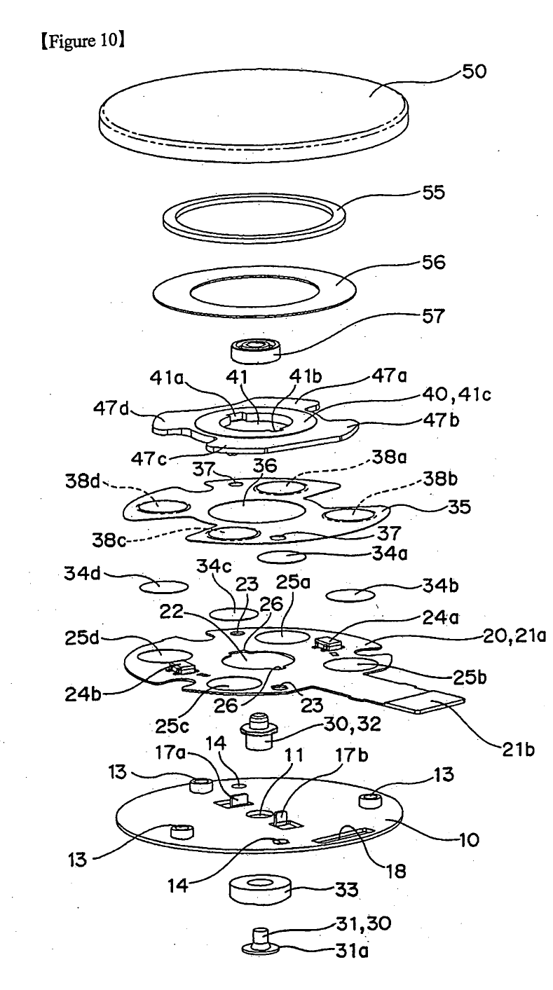

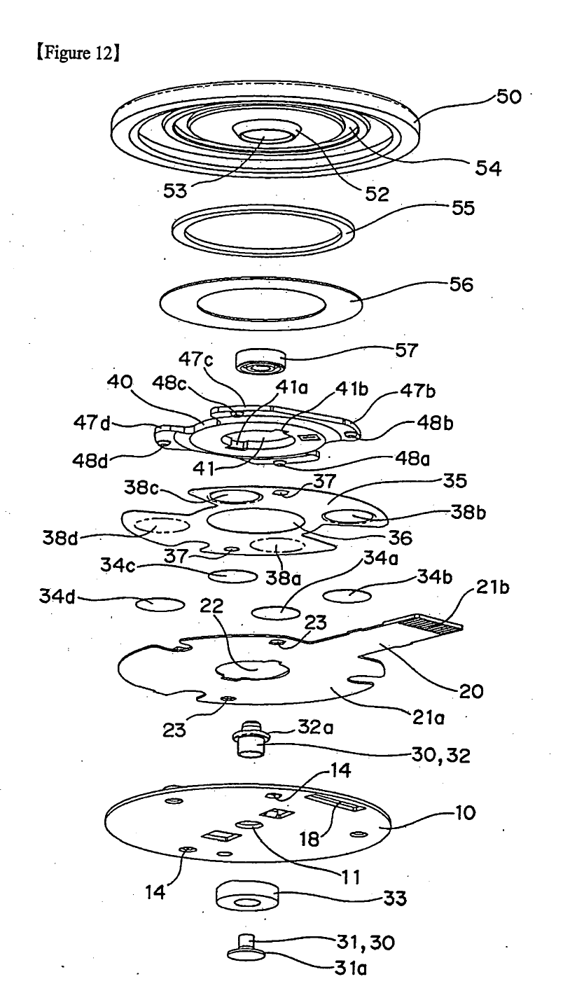

The base 10 is a metal base having a substantially round flat surface as shown in FIGS. 10 and 12 and a plurality of fixing screws 13 on the same circumference with the shaft hole 11 formed at the center as their center. A pair of positioning holes 14 and 14 for assembly is arranged on the basis 10 in such a manner as to interpose the shaft hole 11 between them, and a pair of positioning pawls 17a and 17b are formed by cut-up. An elongated hole 18 capable of inserting the lead portion 21b of the later-appearing printed substrate 20 is formed in the base 10 in the proximity of its outer edge.

The printed substrate 20 includes a substantially round substrate main body 21a covered with peel paper (not shown in the drawings) to the back of which adhesive is applied, and a lead portion 21b. A pair of positioning holes 23 and 23 is formed in the substrate main body 21a in such a manner as to interpose a center hole 22 at the center of the substrate main body 21a between them. A pair of Hall IC 24a and 24b is mounted in such a manner as to interpose the center hole 22 between them. Furthermore, four conductor portions 25a to 25d are arranged in an equal pitch on the same circumference of the substrate main body 21a with the center hole 22 as their center. The printed substrate 20 is bonded to the base 10 as the pair of positioning notches 26 and 26 disposed at the inner peripheral edge of the center hole 22 is meshed with and positioned to the positioning pawls 17a and 17b of the base 10.

The support shaft 30 includes the lower shaft portion 31 and the upper shaft portion 32 that are arranged on the same axis and are detachably integrated with each other by meshing. The lower shaft portion 31, in particular, clamps the ring-like elastic body 33 by its flange portion 31a and the base 10 described above.

The sheet-like insulating cover 35 mounts the flat dome-like button switches 34a to 34d bonded in advance to the bond portions 38a to 38d (FIGS. 10 and 12) of its back surface to the conductor portions 25a to 25d of the substrate main body 21a and covers them, respectively. The sheet-like insulating cover 35 has a pair of positioning holes 37 for assembly with a center hole 36 formed at its center as their center.

The operation plate 40 has positioning notches 41a and 41b that are arranged on the inner surface at the edge of the shaft hole 41 formed at its center, and a ring-like step portion 41c formed at a higher position round the edge portion. The operation plate 40 has four operation tongues 47a to 47d that are arranged on the same circumference and extend with the shaft hole 41 as their center. Operation protuberances 48a to 48d are formed by raise processing at the distal end edge portion of the lower surface of these operation tongues 47a to 47d. The position of the operation plate 40 is restricted in the horizontal direction and does not rotate as the notches 41a and 41b mesh with the positioning pawls 17a and 17b of the base 10.

As shown in FIG. 12, The operation dial 50 has the recess 53 for fixing a later-appearing bearing 57 at the center of the lower end surface of the protuberance 52 that is formed at the center of the lower surface in such a manner as to protrude downward and a ring-like groove 54 for fitting and fixing a ring-like magnet 55 that is concentrically arranged with the recess 53 as the center.

The ring-like magnet 55 has N poles and S poles that are alternately arranged, and is fitted and fixed to the ring-like groove 54 of the operation dial 50. To secure smoother rotation in this embodiment, a sheet-like slide ring 56 having a small coefficient of friction is bonded to the lower surface of the ring-like magnet 55. Therefore, the sheet-like slide ring 56 fitted to the operation dial 50 comes into sliding contact with the upper surface of the operation plate 40. In this embodiment, in particular, the sheet-like slide ring 56 merely comes into sliding contact with the operation tongues 47a to 47d extending from the operation plate 40 and has a small contact area. Therefore, the smoother rotation operation becomes possible.

To secure the smooth rotation of the operation dial 50, the bearing 57 is fitted and fixed to the recess 53 of the operation dial 50. Therefore, the operation dial 50 rotates through the sheet-like slide ring 56 and the bearing 57 and the smooth rotation becomes possible.

Next, the assembly procedure of the operation input device 3 having the constituent components described above will be explained.

First, after the ring-like elastic body 33 is bonded to the edge portion of the back surface of the shaft hole 11 of the base 10, a positioning pin of a jig, not shown, is inserted into the assembly positioning hole 14 of the base 10 for positioning. The positioning notches 26 and 26 of the printed substrate 20 having the pair of Hall IC 24a and 24b mounted thereto are meshed with and positioned and bonded to the positioning pawls 17a and 17b of the base 10. Next, the positioning holes 37 of the sheet-like insulating cover 35 having the push button switches 34a to 34d bonded in advance to the back surface thereof is fitted to the positioning pin of the jig and positioned and bonded to the upper surface of the printed substrate 20. As a result, the push button switches 34a to 34d are electrically connected to the printed substrate 20.

The upper end of the upper shaft portion 32 is inserted into the shaft hole 11 of the base 10 and is meshed with the lower shaft portion 31 in such a manner as to implant the support shaft 30 to the base 10. According to this embodiment, the flange portion 31a of the lower shaft portion 31 and the flange portion 32a of the upper flange portion 32 clamp the base 10 and the ring-like elastic body 33 and prevent their fall-off (see FIGS. 8A and 8B). However, the support shaft 30 has a certain clearance with the shaft hole 11 of the base 10 and can tilt. The notches 41a and 41b of the operation plate 40 are meshed with the positioning pawls 17a and 17b of the base 10 and positioning is made.

On the other hand, the ring-like magnet 55 is fitted and bonded to the ring-like groove 54 of the operation dial 50 and the sheet-like slide ring 56 is bonded to the peripheral base portion of the protuberance 52. The bearing 57 is fitted to the recess 53 disposed in the protuberance 52 and is fixed by the adhesive.

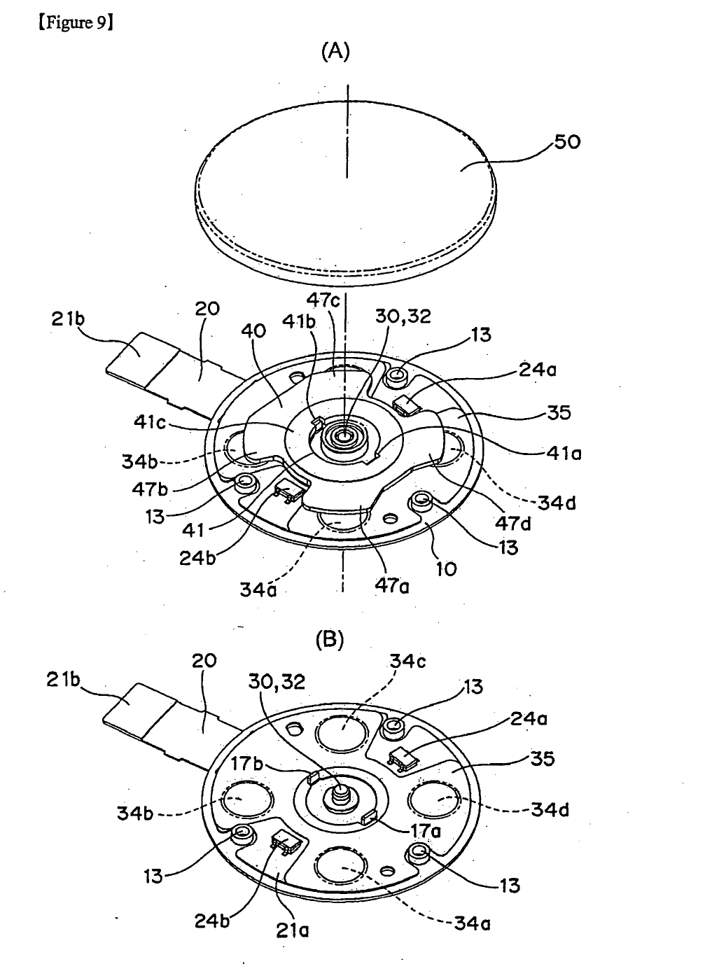

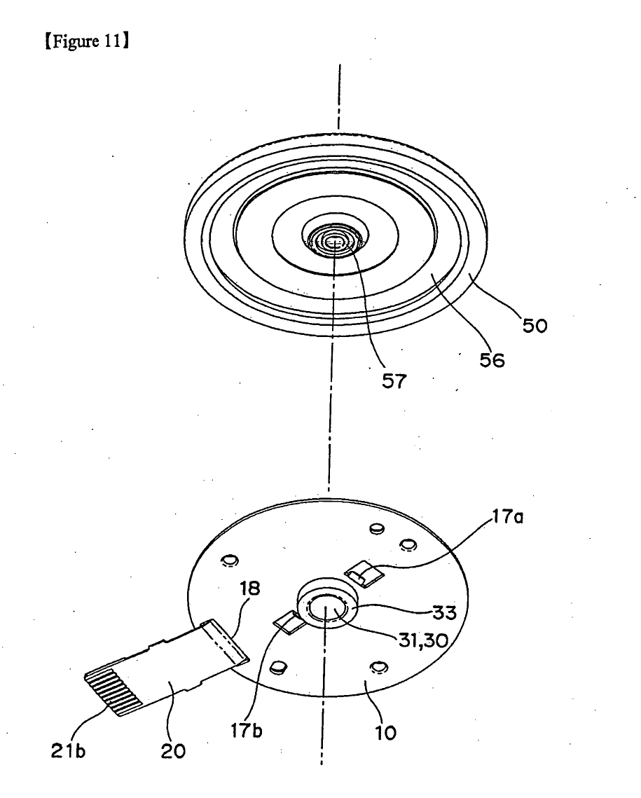

Next, as shown in FIGS. 9A and 11, the bearing 57 fixed to the operation dial 50 is pushed into the upper end of the upper shaft portion 32 exposed from the shaft hole 41 of the operation plate 40 and is integrated with the upper shaft portion 32. In consequence, the operation dial 50 is supported by the support shaft 30 through the bearing 57 in such a manner as to be capable of rotation. Therefore, when the operation plate 40 is pushed down by the operation dial 50, the support shaft 30 inclines and the operation protuberances 48a to 48d of the operation plate 40 drive the corresponding push button switches 34a to 34d.

Next, the operation method of the operation input device 3 having the construction described above will be explained.

When the operation dial 50 is rotated, the ring-like magnet 55 rotates integrally with the operation dial 50 and the pair of Hall IC 24a and 24b detect the change of the magnetic field, respectively, and detect the rotating direction and the rotating distance on the basis of the detection result. The detection result is reflected on the movement of the scroll bar on the screen display of the monitor 2 through a control circuit not shown in the drawings. Incidentally, though the support shaft 30 is supported by the base 10 through the ring-like elastic body 33, unnecessary shake does not occur in the support shaft 30 during the rotation of the operation dial 50 and the desired operation feeling can be secured because the ring-like elastic body 33 has predetermined hardness.

When the scroll bar reaches the desired position, the selection instruction is outputted by pushing the peripheral edge portion of the operation dial 50. In other words, when the outer peripheral edge portion of the operation dial 50 is pushed down, the ring-like elastic body 33 supporting the support shaft 30 undergoes elastic deformation and the support shaft 30 inclines a little. Therefore, the operation dial 50 pushes down the ring-like step portion 41c of the operation plate 40. As a result, the operation protuberance 48a of the operation plate 40 drives the push button switch 34a through the sheet-like insulating cover 35.

The ring-like elastic body 33 returns to its original shape and the support shaft 30 returns to its original position when the operator detaches the finger from the operation dial 50. Consequently, the sheet-like slide ring 56 fitted to the operation dial 50 merely comes into sliding contact with the upper surface of the operation plate 40 and the smooth rotation operation is not lost.

According to this embodiment, the protuberances 48a to 48d are provided to the operation plate 40. Therefore, even when the push-down position of the operator is not correct, the corresponding one of the push button switches 34a to 34d can be correctly pushed down through the operation protuberances 48a to 48d and the operation mistake can be prevented.

The embodiment described above explains the case where the support shaft 30 is implanted to the base 10 while the flange portion 31a of the support shaft 30 and the base 10 clamp the ring-like elastic body 33, but the embodiment is not particularly limited thereto. For example, the support shaft 30 may be implanted to the base 10 in such a manner as to be capable tilting by sandwiching a ring-like elastic body between the inner peripheral surface of the shaft hole 11 of the substrate 10 and the outer peripheral surface of the support shaft 30. The ring-like elastic body 33 may be formed of an elastic material having substantially an L-shaped section.

The operation input device according to the invention is not limited to the mobile telephone but can of course be applied to other mobile appliances and electronic appliances such as mobile music players, television receivers, video players, and so forth.

1. An operation input device comprising:
a base;
a support shaft elastically implanted to and supported by said base in such a manner as to be capable of tilting;
a printed substrate equipped on an upper surface thereof with a plurality of push button switches and magnetic field detection elements mounted thereto, and put on and integrated with said base;
an operation plate arranged on said printed substrate; and
an operation dial having a ring-like magnet having N poles and S poles alternately arranged on a lower surface thereof and supported by an upper end portion of said support shaft in such a manner as to be capable of rotation;
wherein said magnetic flux of said ring-like magnet and a rotating direction when said operation dial is rotated, and said push button switches are driven through said operation plate when an outer peripheral edge portion of said operation dial is pushed down.

2. An operation input device as defined in claim 1, wherein said support shaft is inserted into a shaft hole of said base and a lower surface edge portion of said shaft hole of said base and a lower end flange portion of said support shaft clamp said ring-like elastic body so that said support shaft can be elastically supported by and implanted to said base and can tilt.

3. An operation input device as defined in claim 1, wherein said support shaft is inserted into a shaft hole of said base and said ring-like elastic body is arranged between an inner peripheral surface of said shaft hole of said base and an outer peripheral surface of said support shaft so that said support shaft can be elastically supported by and implanted to said base and can tilt.

4. An operation input device as defined in claim 1, wherein said support shaft comprises a lower shaft portion and an upper shaft portion that are detachably integrated with each other by meshing.

5. An operation input device as defined in claim 1, wherein a slide ring having a small coefficient of friction is arranged between said operation dial and said operation plate.

6. An electronic appliance using said operation input device as defined in claim 1.

7. An operation input device as defined in claim 2, wherein said support shaft is inserted into a shaft hole of said base and said ring-like elastic body is arranged between an inner peripheral surface of said shaft hole of said base and an outer peripheral surface of said support shaft so that said support shaft can be elastically supported by and implanted to said base and can tilt.

8. An operation input device as defined in claim 2, wherein said support shaft comprises a lower shaft portion and an upper shaft portion that are detachably integrated with each other by meshing.

9. An operation input device as defined in claim 3, wherein said support shaft comprises a lower shaft portion and an upper shaft portion that are detachably integrated with each other by meshing.

10. An operation input device as defined in claim 7, wherein said support shaft comprises a lower shaft portion and an upper shaft portion that are detachably integrated with each other by meshing.

11. An operation input device as defined in claim 2, wherein a slide ring having a small coefficient of friction is arranged between said operation dial and said operation plate.

12. An operation input device as defined in claim 3, wherein a slide ring having a small coefficient of friction is arranged between said operation dial and said operation plate.

13. An operation input device as defined in claim 4, wherein a slide ring having a small coefficient of friction is arranged between said operation dial and said operation plate.

14. An operation input device as defined in claim 7, wherein a slide ring having a small coefficient of friction is arranged between said operation dial and said operation plate.

15. An operation input device as defined in claim 8, wherein a slide ring having a small coefficient of friction is arranged between said operation dial and said operation plate.

16. An operation input device as defined in claim 9, wherein a slide ring having a small coefficient of friction is arranged between said operation dial and said operation plate.

17. An electronic appliance using said operation input device as defined in claim 2.

18. An electronic appliance using said operation input device as defined in claim 3.

19. An electronic appliance using said operation input device as defined in claim 4.

20. An electronic appliance using said operation input device as defined in claim 5.
